(19) United States
(12) Patent Application Publication
(10) Pub. No.: US 2005/0001132 A1
(43) Pub. Date: Jan. 6, 2005

(54) Height adjustment cylinder with non-tapered threaded region

(76) Inventors: Jay R. Machael, Muscatine, IA (US); Brian R. Trego, Muscatine, IA (US); Michael J. Birkinbine, Bluegrass, IA (US); Matthew J. Phillips, Muscatine, IA (US)

Correspondence Address: JONES DAY, 77 WEST WACKER, CHICAGO, IL, 60601-1692, US

(21) Appl. No.: 10/461,675

(22) Filed: Jun. 13, 2003

(51) Int. Cl. F16M 11/00

(52) U.S. Cl. 248/405

(57) ABSTRACT

A height adjustment cylinder for use with a desk chair, where the cylinder is simple, reliable and easily assembled with the chair. The cylinder includes a piston shaft which has a threaded region that is of constant diameter or straight walled, and the threaded region includes a high load helical thread.

### CROSS REFERENCE TO RELATED APPLICATION

Not applicable.

### STATEMENT RE FEDERALLY SPONSORED RESEARCH

Not applicable.

### BACKGROUND OF THE INVENTION

1. Field of the Invention

The present invention relates to a height adjustment cylinder and more particularly to a height adjustment cylinder, such as those used in desk chairs, with a non-tapered threaded region where the cylinder is simple, inexpensive and easy to assemble to a chair.

2. Description of the Related Art

Height adjustment cylinders are usually used in office chairs and elsewhere to adjust the vertical height of a seat. The height adjustment cylinder is typically attached to a hub assembly or a control plate where the contacting parts are tapered. Or the cylinder may have a threaded section for mating with a complementary threaded hole. If the mating is improper, the result is excessive wear as well as increased malfunctions and these are very undesirable.

Examples of such cylinders may be found in such prior references as U.S. Pat. No. 3,547,394; 3,711,054; 3,787,019 and 5,806,828.

### BRIEF SUMMARY OF THE INVENTION

The difficulties encountered with previous devices have been overcome by the present invention. What is described here is a height adjustment cylinder with a non-tapered threaded section including an elongated cylinder housing and a piston movable in the cylinder housing, the piston having a shaft with an end region extending away from the cylinder, the end region having a substantially constant diameter with a screw thread formed thereon and a shoulder formed adjacent to the screw thread.

There are a number of advantages, features and objects achieved with the present invention which are believed not to be available in earlier related devices. For example, one advantage is that the present invention provides a height adjustment cylinder which may be easily and quickly assembled with a chair. Another object of the present invention is to provide a height adjustment cylinder which is relatively simple and inexpensive. Yet other features are that positioning of the cylinder is always correct and consistent.

A more complete understanding of the present invention and other objects, advantages and features thereof will begin from a consideration of the following description of a preferred embodiment read in conjunction with the accompanying drawing provided herein. The embodiment represents an example of the invention which is described here in compliance with Title 35 U.S.C. § 112 (1st Paragraph), but the invention itself is defined by the attached claims.

### BRIEF DESCRIPTION OF THE SEVERAL VIEWS OF THE DRAWING

FIG. 1 is an isometric view of a desk chair having a height adjustment cylinder.

FIG. 2 is an enlarged elevation view of the height adjustment cylinder with a non-tapered threaded region.

FIG. 3 is a partial diagrammatic sectional view showing the height adjustment cylinder mated with a hub.

FIG. 4 is an enlarged elevation view of a height adjustment cylinder with a non-tapered threaded region and a high load helical thread.

FIG. 5 is a diagrammatic, partially exploded, plan view of a hub receiving opening and a pair of set screws.

### DETAILED DESCRIPTION OF A PREFERRED EMBODIMENT OF THE INVENTION

While the present invention is open to various modifications and alternative constructions, the preferred embodiment shown in the various figures of the drawing will be described herein in detail. It is understood however, that there is no intention to limit the invention to the particular embodiment, form or example disclosed. On the contrary, the intention is to cover all modifications, equivalent structures and methods and alternative constructions falling within the spirit and scope of the invention as expressed in the appended claims, pursuant to Title 35 U.S.C. § 112 (2nd Paragraph).

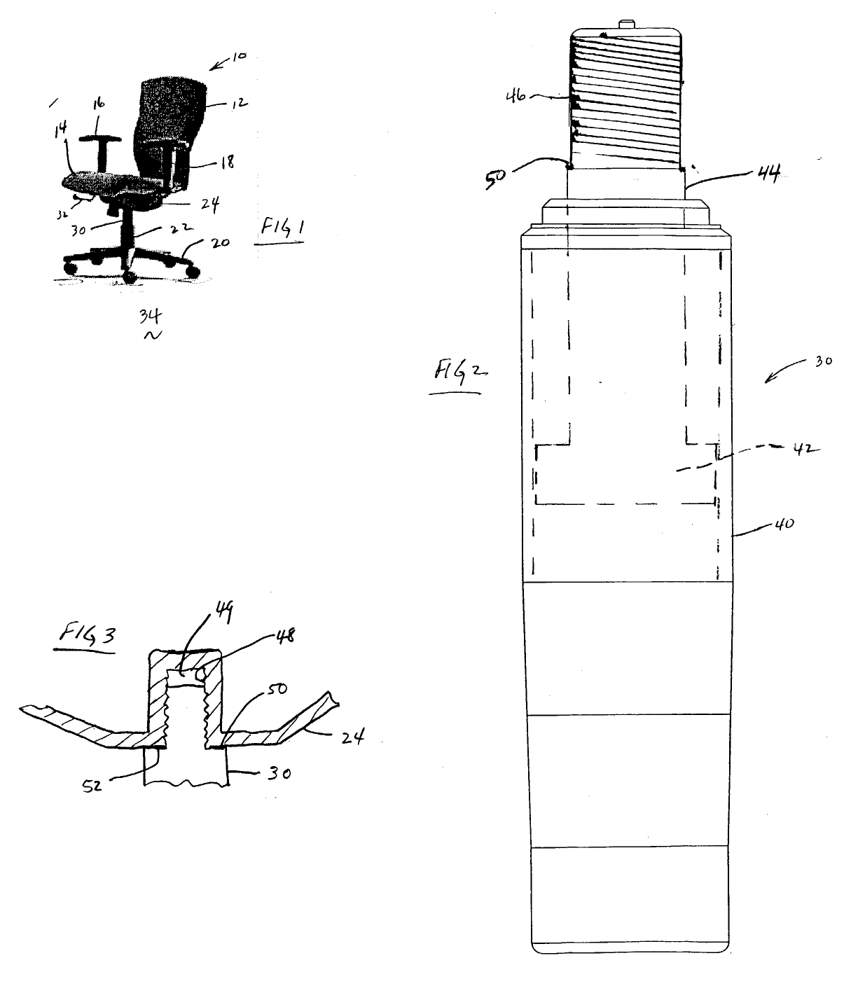

Referring now to FIG. 1, a desk chair 10 is illustrated having a back 12, a seat 14, a pair of side arms 16, 18, a base 20 and a column 22. Beneath the seat 14 and fixed to the column is a hub 24.

The column 22 includes a pneumatic seat height adjustment cylinder 30, FIGS. 1 and 2. A lever 32 is provided for activating the cylinder to adjust the vertical height of the seat 14 relative to a floor 34 upon which the chair is supported.

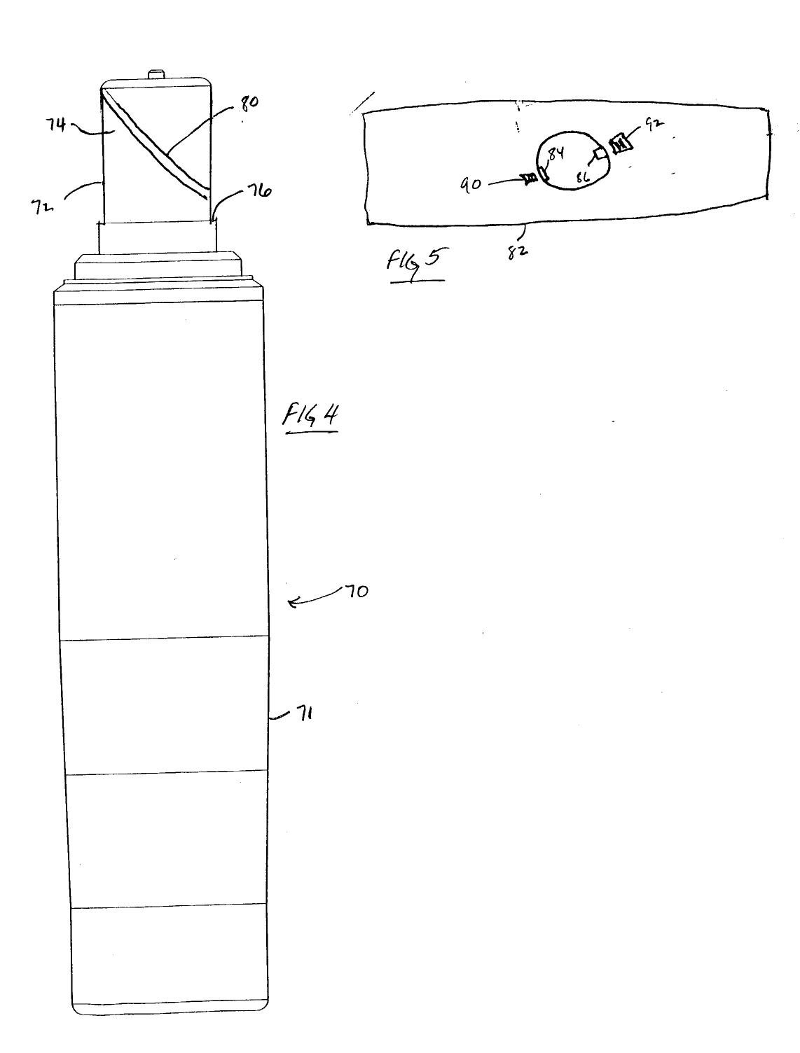

The height adjustment cylinder 30 includes a housing 40, FIG. 2, in which a piston 42 rides upwardly and downwardly. The adjusted location of the piston is determined by a user for his/her comfort. The piston is connected to a piston rod or shaft 44 having a threaded region 46 at its upper end portion. The threaded region has an external thread and a constant diameter as shown. This results in a “straight walled” shaft as opposed to a more common tapered shaft. The threaded region 46 is on the outer diameter of the threaded region and is engageable with an internal thread 48, FIG. 3, in an aperture or hole 49 formed in the hub 24. The threaded region of the shaft terminates at a shoulder or step 50 which acts to limit the length of insertion of the shaft into the aperture of the hub and provides precise locating. The shoulder of the shaft abuts an annular surface 52 formed on the hub.

A major advantage of this construction is that the cylinder and the hub may be assembled easily simply by rotating the two parts together to engage the threads of one with the threads of the other. Proper location is automatically decided because of the abutment between the shoulder 50 of the shaft and the surface 52 of the hub. This ensures that the shaft will be limited in its insertion into the aperture thereby making the engagement of the hub and the cylinder consistent from one assembled chair to the next.

Referring to FIGS. 4 and 5, a height adjustment cylinder 70 with an elongated housing 71 is illustrated having a piston and a shaft 72 similar to those shown in dotted line in FIG. 2. The shaft has a threaded region 74 having a constant diameter, that is, straight walled, rather than the usual tapered geometry. The piston shaft also has a shoulder 76. As mentioned, the shoulder results in precisely locating the cylinder relative to the hub or control plate and ensures a consistency in assembly production.

The threaded region differs from that shown in FIG. 2 in that in the FIG. 4 cylinder, the threaded region 74 has a high load helical thread 80. This thread is much more vertically oriented that the usual screw thread.

A hub 82, FIG. 5 (or control plate), includes bosses 84, 86 and set screws 90, 92. These are used to secure the cylinder to the hub (or control plate). By so doing, a height adjustment cylinder lever requires no additional adjustment and a proper placement of an activator pin is precise.

The above specification describes in detail a preferred embodiment of the present invention. Other examples, embodiments, modifications and variations will, under both the literal claim language and the doctrine of equivalents, come within the scope of the invention defined by the appended claims. For example, changing the pitch angle of the helical thread is considered an equivalent structure and will also come within the literal language of the claims. Still other alternatives will also be equivalent as will many new technologies. There is no desire or intention here to limit in any way the application of the doctrine of equivalents nor to limit or restrict the scope of the invention.

1. A height adjustment cylinder with a non-tapered threaded shaft comprising:
an elongated housing; and
a piston movable in said housing, said piston having a piston head completely enclosed by said housing and a shaft extending partially in said housing and partially out of said housing, said shaft having an end portion extending away from said housing, said shaft having a substantially constant diameter with a screw thread formed on said end portion, and a shoulder formed adjacent to said screw thread to limit the axial insertion of the said portion into a chair hub.

2. The apparatus as claimed in claim 1 wherein:
said screw thread includes a high load helical thread.

3. A height adjustment assembly for a chair comprising:
a cylinder having a tubular shape with an inner surface, an outer surface, a closed lower end portion and an open upper end portion; and
a piston movable within said cylinder in a reciprocal manner, said piston including a piston head totally enclosed by said cylinder and a rod connected to the piston head and extending away therefrom, said piston head being movable along the inner surface of said cylinder and said rod extending out of said open upper end portion of said cylinders, said rod having a substantially constant cross section, with a non-threaded portion, a threaded end portion and a shoulder separating said threaded end portion from said non-threaded portion.

4. The height adjustment assembly of claim 3 wherein:
said threaded end portion includes a high load helical thread.

5. The height adjustment assembly of claim 3 wherein:
the diameter of said threaded end portion of said rod is substantially constant and is non-tapered.

6. The height adjustment assembly of claim 5 wherein:
said threaded end portion includes a high load helical thread.

7. An adjustable, swivel chair assembly comprising:
a seat;
a back connected to said seat;
a base for supporting said seat and said back;
an adjustable column mounted to said base; and
a hub mounted under said seat, said adjustable column including a cylinder and a piston movable within said cylinder in a reciprocal manner, said piston including a piston head totally enclosed by said cylinder and a rod connected to the piston head and extending away therefrom, said rod having a substantially constant cross section, with a non-threaded portion, a threaded end portion and a shoulder separating said threaded end portion from said non-threaded portion, said threaded end portion being threadedly engaged with said under seat mounted hub such that said shoulder of said rod contacts said hub.

8. The chair of claim 7 wherein:
said cylinder has a tubular shape with an inner surface, an outer surface, a closed lower end portion and an open upper end portion.

9. The chair of claim 8 wherein:
said piston head is movable along said inner surface of said cylinder.

10. The chair of claim 8 wherein:
said rod extends out of said open upper end portion of said cylinder.

11. The chair of claim 10 wherein:
said piston head is movable along said inner surface of said cylinder.

12. The chair of claim 11 wherein:
said threaded end portion of said rod includes a high load helical thread.

13. The chair of claim 7 wherein:
said threaded end portion of said rod includes a high load helical thread.

14. The chair of claim 13 wherein:
said rod extends out of an open upper end portion of said cylinder.

15. The chair of claim 7 wherein:
said hub includes an opening and at least one set screw for engaging said rod.

16. The chair of claim 15 wherein:
said rod extends out of an open upper end portion of said cylinder.

17. The chair of claim 16 wherein:
said threaded end portion of said rod includes a high load helical thread.

18. A method for assembling an adjustable swivel chair comprising the steps of:
providing a chair seat;
providing a chair back;
providing a chair base;
providing a chair column, wherein said column includes a cylinder and a piston and said piston includes a piston head totally enclosed by said cylinder and a rod, and said rod having a non-threaded portion, a non-tapered, threaded end portion and a shoulder;
attaching said column to said base;
providing an under seat hub;
attaching said hub to said seat; and
inserting said threaded end portion of said rod into said hub until said shoulder engages said hub.

19. The method of claim 19 wherein:
said threaded end portion includes a high load helical thread.

20. The method of claim 19 wherein:
said hub includes a threaded opening and a set screw positioned adjacent said opening; and
including the steps of:
engaging said threaded end portion of said rod with the hub through said threaded opening; and
engaging said threaded end portion of said rod with said set screw.
